(19) United States
(12) Patent Application Publication
(10) Pub. No.: US 2024/0098742 A1
(43) Pub. Date: Mar. 21, 2024

(54) ENABLING DYNAMIC SWITCHING BETWEEN MULTIPLE TRANSMISSION RECEPTION POINTS AND SINGLE TRANSMISSION RECEPTION POINTS PHYSICAL UPLINK CONTROL CHANNEL SCHEMES

(71) Applicant: Nokia Technologies Oy, Espoo (FI)

(72) Inventors: Matha DEGHEL, Montrouge (FR); Keeth Saliya Jayasinghe LADDU, Espoo (FI); Youngsoo YUK, Seoul (KR)

(21) Appl. No.: 18/256,522

(22) PCT Filed: Dec. 20, 2021
(86) PCT No.: PCT/EP2021/086701

§ 371 Date: Jun. 8, 2023

Related U.S. Application Data
(60) Provisional application No. 63/128,991, filed on Dec. 22, 2020.

(51) Int. Cl. H04W 72/20; H04L 5/00

(52) U.S. Cl. CPC H04W 72/20; H04L 5/0035

(57) ABSTRACT

Systems, methods, apparatuses, and/or computer program products for dynamically switching between or determining whether to apply single-TRP mode and/or multiple-TRP mode are provided. One method may include receiving, at a user equipment, configuration information indicating that multi-transmission reception point (TRP) physical uplink control channel (PUCCH) scheme could be applicable, and determining, at the user equipment, whether to apply the multi-TRP PUCCH scheme or a single-TRP PUCCH scheme for an uplink control information (UCI) transmission on a determined PUCCH resource.

### CROSS-REFERENCE TO RELATED APPLICATIONS

This application claims priority from U.S. provisional patent application No. 63/128,991 filed on Dec. 22, 2020. The entire contents of this earlier filed application are hereby incorporated by reference in their entirety.

### FIELD

Some example embodiments may generally relate to communications is including mobile or wireless telecommunication systems, such as Long Term Evolution (LTE) or fifth generation (5G) radio access technology or new radio (NR) access technology, or other communications systems. For example, certain example embodiments may generally relate to systems, methods and/or apparatuses for switching between single transmission reception point (TRP) mode and multiple TRP mode.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method, which may include receiving, at a user equipment, configuration information indicating that multi-transmission reception point (TRP) physical uplink control channel (PUCCH) scheme could be applicable, and determining, at the user equipment, whether to apply the multi-TRP PUCCH scheme or a single-TRP PUCCH scheme for an uplink control information (UCI) transmission on a determined PUCCH resource.

An embodiment may be directed to an apparatus including at least one processor and at least one memory comprising computer program code. The at least one memory and computer program code configured, with the at least one processor, to cause the apparatus at least to: receive configuration information indicating that multi-transmission reception point (TRP) physical uplink control channel (PUCCH) scheme could be applicable, and determine whether to apply the multi-transmission reception point (TRP) physical uplink control channel (PUCCH) scheme or a single-transmission reception point (TRP) physical uplink control channel (PUCCH) scheme for an uplink control information (UCI) transmission on a determined physical uplink control channel (PUCCH) resource.

An embodiment may be directed to an apparatus including means for receiving configuration information indicating that multi-transmission reception point (TRP) physical uplink control channel (PUCCH) scheme could be applicable. The apparatus may also include means for determining whether to apply the multi-transmission reception point (TRP) physical uplink control channel (PUCCH) scheme or a single-transmission reception point (TRP) physical uplink control channel (PUCCH) scheme for an uplink control information (UCI) transmission on a determined physical uplink control channel (PUCCH) resource.

In a variant, the determining of whether to apply the multi-TRP PUCCH scheme or a single-TRP PUCCH scheme includes determining whether to apply multi-TRP PUCCH scheme or single-TRP PUCCH scheme based on at least one of: the received configuration information, the determined PUCCH resource, whether one or two different spatial relation information have been indicated or activated for the PUCCH resource, whether one or two subsets of power control parameters have been indicated or activated for the PUCCH resource, or indicated or configured number of PUCCH repetitions.

In another variant, the determining of whether to apply the multi-TRP PUCCH scheme or a single-TRP PUCCH scheme includes receiving, from a network node, a dedicated indication via downlink control information (DCI) to indicate whether to apply the multi-TRP PUCCH scheme or single-TRP PUCCH scheme.

According to a variant, the method may also include receiving, from a network node, downlink control information (DCI) carrying information related to uplink control information (UCI) to be transmitted.

In a variant, when it is determined to apply the multi-TRP PUCCH scheme, the method may include interpreting at least one DCI field by considering an entirety of the at least one field in case of the multi-TRP PUCCH scheme and determining two parameter values based on the at least one field.

According to a variant, when it is determined that the multi-TRP PUCCH scheme is not applied, the method may include interpreting at least one DCI field by considering one part or subfield of the at least one field in case of single-TRP PUCCH scheme and determining a parameter value based on the one part or subfield.

In a variant, when a PUCCH resource is determined for which two spatial relation information are indicated or activated and/or the number of PUCCH repetitions is greater than one, the determining comprises determining to apply the multi-TRP PUCCH scheme.

In another variant, when a PUCCH resource is determined for which two subsets of power control parameters are indicated or activated, and/or the number of PUCCH repetitions is greater than one or equal to one, the determining comprises determining to apply the multi-TRP PUCCH scheme.

In another variant, the configuration information may be received via at least one of radio resource control (RRC) or medium access control (MAC) control element (CE).

### BRIEF DESCRIPTION OF THE DRAWINGS

For proper understanding of example embodiments, reference should be made to the accompanying drawings, wherein:

FIG. 1 illustrates an example flow diagram of a method, according to an embodiment;

FIG. 2 illustrates another example flow diagram of a method, according to an embodiment;

FIG. 3A illustrates an example block diagram of an apparatus, according to an embodiment; and

FIG. 3B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and/or computer program products for dynamically switching between single-TRP mode and multiple-TRP mode, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Physical uplink control channel (PUCCH) resource determination may depend on one or more of: PUCCH resource index (PRI) in downlink control information (DCI), uplink control information (UCI) payload size, first control channel element (CCE) index of the physical downlink control channel (PDCCH) carrying the DCI, the total number of CCEs in the control resource set (CORESET) on which the PDCCH carrying the DCI has been transmitted, UCI configuration (such as scheduling request (SR) configuration, channel state information (CSI) configuration, semi-persistent scheduling (SPS) hybrid automatic repeat request (HARQ)-acknowledgment (ACK) configuration).

Two main ways a UE can use to determine the PUCCH resource for a given UCI transmission on PUCCH are described as follows. In case of HARQ-ACK corresponding to a PDCCH, PUCCH resource determination may be based on PRI (PUCCH resource indicator) in DCI and UCI payload size. In cases of SR, CSI, and HARQ-ACK without a corresponding PDCCH, the UE may determine the PUCCH resource from the corresponding UCI configuration, where the selected PUCCH resource may depend on the UCI payload size. The various ways for PUCCH resource determination can be found in 3GPP technical specification (TS) 38.213.

A UE may determine the PUCCH transmission power based on the procedure described in the 3rd generation partnership project (3GPP) technical specification (TS) 38.213. In summary, the UE is indicated or determines closed-loop parameters (closed-loop index, transmit power control (TPC) command) and open-loop parameters (pathloss reference RS, p0); it is noted that there is no fractional pathloss compensation for PUCCH power control. The TPC command(s) is carried within downlink (DL) scheduling assignments. One reason for uplink (UL) PUCCH transmissions is the transmission of HARQ-ACK as a response to physical downlink shared channel (PDSCH) transmissions. Also, TPC command (and corresponding closed-loop index) can be carried jointly to multiple UEs by means of group-common DCI.

In 3GPP Release-17, an objective of enhancements for multi-TRP is to identify and specify features to improve reliability and robustness for channels other than physical downlink shared channel (PDSCH) (i.e., PDCCH, PUSCH, and PUCCH) using multi-TRP and/or multi-panel, with Release-16 reliability features as the baseline.

Regarding the support of multi-TRP PUCCH transmission/repetition schemes, it has been agreed to support TDMed PUCCH scheme(s) to improve reliability and robustness for PUCCH using multi-TRP and/or multi-panel. Alternatives being studied include supporting both inter-slot repetition and intra-slot repetition/intra-slot beam hopping, or supporting just inter-slot repetition. This does not preclude studying the use of multiple PUCCH resources to repeat the same UCI in both inter-slot repetition and intra-slot repetition. For inter-slot repetition, one PUCCH resource carries UCI, another one or more PUCCH resources or the same PUCCH resource in another one or more slots carries a repetition of the UCI. For intra-slot repetition, one PUCCH resource carries UCI, another one or more PUCCH resources or the same PUCCH resource in another one or more sub-slots carries a repetition of the UCI. For intra-slot beam hopping, UCI is transmitted in one PUCCH resource in which different sets of symbols have different beams.

On the multi-TRP PUCCH schemes, it has been further agreed that for multi-TRP TDMed PUCCH transmission schemes, the use of a single PUCCH resource is supported, and up to two spatial relation information can be activated per PUCCH resource via medium access control (MAC) control element (CE).

The support of a single PUCCH resource implies that a single PUCCH resource will be used for the different (TDM-ed) repetitions towards different TRPs. And, up to two spatial relation information can be indicated/activated for a PUCCH resource via MAC CE.

In addition, the following was agreed regarding the multi-TRP PUCCH related power control enhancements, allowing separate power control parameters for different TRPs. For PUCCH multi-TRP enhancements in frequency range 2 (FR2), separate power control parameters for different TRP are supported via associating power control parameters via PUCCH spatial relation info. For per TRP closed-loop power control for PUCCH, several alternatives are being studied considering TPC command when the “closedLoopindex” values associated with the two PUCCH spatial relation info's are not the same. In a first alternative (option 1), a single TPC field is used in DCI formats 1_1/1_2, and the TPC value applied for both PUCCH beams. In a second alternative (option 2), a single TPC field is used in DCI formats 1_1/1_2, and the TPC value applied for one of two PUCCH beams at a slot. The TPC value may be applied for the other PUCCH beam at another slot. In a third alternative (option 3), a second TPC field is added in DCI formats 1_1/1_2. In a fourth alternative (option 4), a single TPC field is used in DCI formats 1_1/1_2, and indicates two TPC values applied to two PUCCH beams, respectively.

For PUCCH multi-TRP enhancements in frequency range 1 (FR1), it has been agreed to support separate power control for different TRP. It has been left for further study how to define the association between PUCCH and TRP.

As explained above, multi-TRP PUCCH transmission/repetition schemes are defined, and will be specified in Release-17 NR. However, there are some unresolved issues related to the support of single/multi-TRP switching.

For critical services such as URLLC, it is beneficial to use multi-TRP PUCCH schemes so that reliability/robustness is guaranteed, e.g., by relying on beam diversity. For example, it is possible to repeat the same UCI towards the multiple TRPs such that network can overcome blockage scenarios. However, in certain instances of time, the network may wish to receive UCI repetition towards the same TRP. To allow such flexibility, it is understood that support of dynamic switching between different repetition modes (or transmission modes) may be required.

However, switching between single-TRP mode and multi-TRP mode has thus far not been provided. Besides, once the operating mode (multi-TRP vs single TRP) is determined, it is also currently unresolved how to determine some parameter(s) values for which the indication/interpretation could be different depending on whether the single-TRP PUCCH scheme or multi-TRP PUCCH scheme is used.

In view of at least the above-noted issues, certain example embodiments are configured to enable a UE to determine whether to apply multi-TRP PUCCH scheme or single-TRP PUCCH scheme and, for at least one DCI field, to determine or interpret corresponding parameter value(s) depending on the applicable PUCCH scheme.

In an example embodiment, a UE may determine the mode of operation from multi-TRP PUCCH or single TRP PUCCH based at least on one of two alternatives. According to a first alternative, the determination of the mode of operation, i.e., whether to apply multi-TRP PUCCH scheme or single-TRP PUCCH scheme, may be based on at least one of: (a) a dynamic indication of the mode of operation using the PUCCH resource's spatial relation information indicated via MAC CE, (b) dynamic indication of the mode of operation using the PUCCH resource's power control parameters subset(s) indicated via MAC CE, (c) semi-static configuration (via RRC configuration) of the mode of operation, (d) semi-static configuration for PUCCH resource associating mode of operation, (e) based on the number of PUCCH repetitions, or (f) any combination of the above. It should be noted that a subset of (PUCCH) power control parameters could contain at least one of: p0 value index, Pathloss reference RS index, closed-loop index. More generally, a subset of power control parameters could contain at least one of open-loop and/or closed-loop power control parameters.

According to an embodiment, when the determination of the mode of operation is made based on a dynamic indication of the mode of operation using the PUCCH resource's spatial relation information, then the mode of operation may be determined based on whether one or two (different) spatial relation information have been indicated for this PUCCH resource.

In an embodiment, when the determination of the mode of operation is made based on a dynamic indication of the mode of operation using the PUCCH resource's power control parameters subset(s) indicated, then the mode of operation may be determined based on whether one or two (different) subsets of power control parameters have been indicated for this PUCCH resource.

According to an embodiment, when the determination of the mode of operation is made based on a semi-static configuration (e.g., via RRC configuration) of the mode of operation, this may include, for example, indicating (or not) that multi-TRP PUCCH scheme or single-TRP PUCCH scheme is applied.

In an embodiment, when the determination of the mode of operation is made based on a semi-static configuration for PUCCH resource associating mode of operation, then the UE may determine the mode of operation based on scheduled/configured PUCCH resource. For example, each PUCCH resource may be explicitly associated (e.g., via RRC) to a given mode of operation. It is noted that the PUCCH resource determination may depend on at least one of: PUCCH resource indicator (PRI) in DCI, UCI payload size, the first CCE index of the PDCCH carrying the DCI, the total number of CCEs in the CORESET on which the PDCCH carrying the DCI has been transmitted, UCI configuration (such as SR configuration, CSI configuration, SPS HARQ-ACK configuration).

According to an embodiment, when the determination of the mode of operation is made based on the number of PUCCH repetitions, this number may be configured via RRC, and/or dynamically indicated, in an implicit or explicit manner, via DCI.

Additionally, in certain embodiments, the determination of the mode of operation may be made based on any combination of the above. For example, for both approaches involving semi-static configuration, if the PUCCH resource is associated with single TRP mode, but PUCCH resource has multiple spatial relation info activated or any other multiple parameters activated for multi-TRP operation via dynamic signalling (e.g., MAC-CE), the multi-TRP mode may be considered by overwriting semi-static configuration.

The above options for determining whether multi-TRP PUCCH scheme or single TRP PUCCH should be applied for a given UCI transmission may further consider the following variants. In a first variant, (e.g., mainly for FR2, and intra-slot and inter-slot PUCCH repetition schemes), if multi-TRP PUCCH scheme is configured via RRC (e.g., the semi-static configurations in options (c) and (d) above) and the UE determines a PUCCH resource for which two spatial relation information are indicated/activated (e.g., dynamic indication in option (a) above), and the number of PUCCH repetitions is greater than one, then the multi-TRP PUCCH scheme may be applied. Otherwise, the single-TRP PUCCH scheme may be applied. Here, in certain embodiments, the number of repetitions may be configured separately for each PUCCH resource or may be jointly configured for a group of PUCCH resources, or can be explicitly indicated via DCI.

In a second variant (e.g., mainly for FR2, and intra-slot PUCCH beam hopping scheme), if multi-TRP PUCCH scheme is configured via RRC (e.g., semi-static configuration options (c) and (d) above) and the UE determines a PUCCH resource for which two spatial relation information are indicated/activated (e.g., dynamic indication option (a) above), and the number of repetition is equal to one, then the multi-TRP PUCCH scheme may be applied. Otherwise, the single-TRP PUCCH scheme may be applied.

In a third variant (e.g., mainly for FR1, and intra-slot and inter-slot PUCCH repetition schemes), if multi-TRP PUCCH scheme is configured via RRC (e.g., semi-static configuration options (c) and (d) above) and the UE determines a PUCCH resource for which two subsets of power control parameters are indicated/activated (e.g., the dynamic indication option (b) above), and the number of PUCCH repetitions is greater than one, then the multi-TRP PUCCH scheme may be applied. Otherwise, the single-TRP PUCCH scheme may be applied. Here, in some embodiments, the number of repetitions may be configured separately for each PUCCH resource or may be jointly configured for a group of PUCCH resources or may be explicitly indicated via DCI.

According to a fourth variant (e.g., mainly for FR1, and intra-slot PUCCH beam hopping scheme), if multi-TRP PUCCH scheme is configured via RRC (e.g., semi-static configuration options (c) and (d) above) and the UE determines a PUCCH resource for which two subsets of power control parameters are indicated/activated (e.g., the dynamic indication option (b) above), and the number of repetition is equal to one, then the multi-TRP PUCCH scheme may be applied. Otherwise, the single-TRP PUCCH scheme may be applied.

According to a second alternative, a UE may be provided with dedicated indication via downlink control information (DCI) to indicate whether to apply the multi-TRP PUCCH scheme or single-TRP PUCCH scheme. For example, according to an embodiment, in addition to the current RNTIs that can be used to indicate that single-TRP scheme should be applied (based on C-RNTI), a dedicated RNTI (scrambling DCI) may be used to indicate whether multi-TRP PUCCH scheme should be applied. As another example, one explicit DCI field can be used in a UE-specific DCI and/or group-common DCI to indicate whether to apply the multi-TRP PUCCH scheme or single-TRP PUCCH scheme.

Based on the determination and/or indication of whether to apply the multi-TRP PUCCH scheme or single-TRP PUCCH scheme, for which the different alternatives are discussed above, the UE may interpret at least one DCI field, which may have the same size regardless of which scheme is applicable.

According to certain embodiments, the UE may interpret the DCI field(s) using at least one of the following approaches. In one approach, the UE may consider one part or subfield of the field in case of single-TRP PUCCH scheme and may determine the parameter value based on this part/subfield; the UE may consider the entire field (i.e., two subfields) in case of multi-TRP PUCCH scheme and may determine two parameter values based on this field. For instance, the above could be applied in case TPC field comprised of two TPC subfields each of which may contain a TPC command value.

In another approach, when the field is used as a codepoint pointing to two parameter values indicated via MAC CE (or RRC), the UE may determine one parameter value (first or second) from the two values indicated via MAC CE (or RRC) in case of single-TRP scheme; the UE may determine and/or use the two values indicated via MAC CE (or RRC) in case of multi-TRP PUCCH scheme. For instance, the above could be applied in case TPC field in DCI is used as a codepoint associated, e.g., via MAC CE, to two TPC command values.

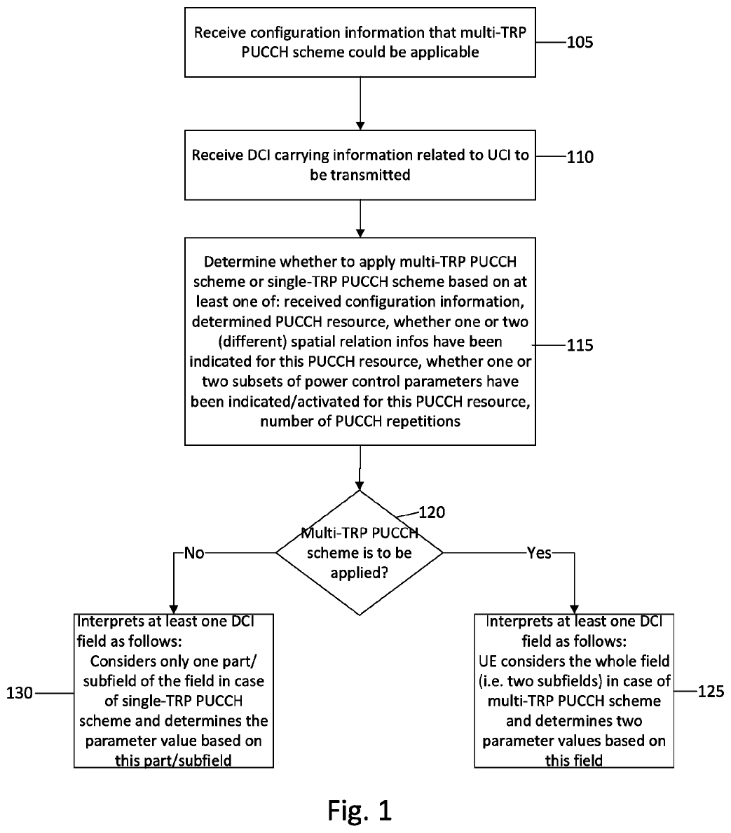

FIG. 1 illustrates an example flow diagram of a method for determining by a UE whether to apply a multi-TRP or single-TRP scheme, according to one embodiment. In certain example embodiments, the flow diagram of FIG. 1 may be performed by a network entity or network node in a communications system, such as LTE or 5G NR. In some example embodiments, the network entity performing the method of FIG. 1 may include or be included in a UE, SL UE, relay UE, mobile station, mobile device, stationary device, a wireless transmit/receive unit, IoT device or sensor, or the like.

As illustrated in the example of FIG. 1, the method may include, at 105, receiving configuration information that multi-TRP PUCCH scheme could be applicable. The method may also include, at 110, receiving, from a network node, DCI carrying information related to the UCI to be transmitted. In an embodiment, the method may then include, at 115, determining whether to apply multi-TRP PUCCH scheme or single-TRP PUCCH scheme, e.g., based on one or more of the factors or options (a)-(f) discussed above. For example, the determining 115 of whether to apply multi-TRP PUCCH scheme or single-TRP PUCCH scheme may be based on at least one of: the received configuration information, the determined PUCCH resource, whether one or two (different) spatial relation information have been indicated for this PUCCH resource, whether one or two subsets of power control parameters have been indicated/activated for this PUCCH resource, and/or the number of PUCCH repetitions.

In certain embodiments, when it is determined at 120 to apply a multi-TRP PUCCH scheme, then the method may include, at 125, interpreting at least one DCI field by considering the entire field (i.e., two subfields) in case of multi-TRP PUCCH scheme and determining two parameter values based on this field. According to some embodiments, when it is determined at 120 that a multi-TRP PUCCH scheme is not applied, then the method may include, at 130, interpreting at least one DCI field by considering one part or subfield in case of single-TRP PUCCH scheme and determining the parameter value based on this part or subfield.

It is noted that, according to certain embodiments, the method depicted in FIG. 1 may be applied in FR1 and/or FR2, or any other frequency range.

For instance, for FR2 and intra-slot and inter-slot PUCCH repetition schemes, if multi-TRP PUCCH scheme is configured via RRC and the UE determines a PUCCH resource for which two spatial relation information are indicated or activated, and the number of PUCCH repetitions is greater than one, then the determining 115 may include determining to apply the multi-TRP PUCCH scheme. Otherwise, the determining 115 may include determining to apply the single-TRP PUCCH scheme. As mentioned above, in certain embodiments, the number of repetitions may be configured separately for each PUCCH resource or may be jointly configured for a group of PUCCH resources, or can be explicitly indicated via DCI.

As another example, for FR2 and intra-slot PUCCH beam hopping scheme, if multi-TRP PUCCH scheme is configured via RRC and the UE determines a PUCCH resource for which two spatial relation information are indicated or activated, and the number of repetition is equal to one, then the determining 115 may include determining to apply the multi-TRP PUCCH scheme. Otherwise, the determining 115 may include determining to apply the single-TRP PUCCH scheme.

In another embodiment, for FR1 and intra-slot and inter-slot PUCCH repetition schemes, if multi-TRP PUCCH scheme is configured via RRC and the UE determines a PUCCH resource for which two subsets of power control parameters are indicated or activated, and the number of PUCCH repetitions is greater than one, then the determining 115 may include determining to apply the multi-TRP PUCCH scheme. Otherwise, the determining 115 may include determining to apply single-TRP PUCCH scheme. As mentioned above, in some embodiments, the number of repetitions may be configured separately for each PUCCH resource or may be jointly configured for a group of PUCCH resources or may be explicitly indicated via DCI.

According to a further embodiment, for FR1 and intra-slot PUCCH beam hopping scheme, if multi-TRP PUCCH scheme is configured via RRC and the UE determines a PUCCH resource for which two subsets of power control parameters are indicated or activated, and the number of repetition is equal to one, then the determining 115 may include determining to apply the multi-TRP PUCCH scheme. Otherwise, the determining 115 may include determining to apply the single-TRP PUCCH scheme.

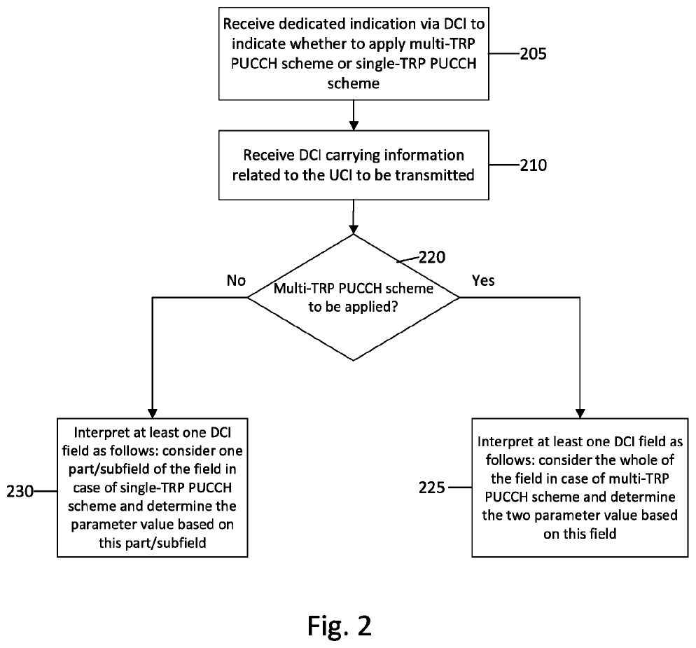

FIG. 2 illustrates an example flow diagram of a method for determining by a UE whether to apply a multi-TRP or single-TRP scheme, according to an embodiment. In certain example embodiments, the flow diagram of FIG. 2 may be performed by a network entity or network node in a communications system, such as LTE or 5G NR. In some example embodiments, the network entity performing the method of FIG. 1 may include or be included in a UE, SL UE, relay UE, mobile station, mobile device, stationary device, a wireless transmit/receive unit, IoT device or sensor, or the like.

As illustrated in the example of FIG. 2, the method may include, at 205, receiving, from a network node, dedicated indication via downlink control information (DCI) to indicate whether to apply multi-TRP PUCCH scheme or single-TRP PUCCH scheme. For example, the receiving 205 may include, in addition to current RNTI(s) that can be used to indicate that single-TRP scheme should be applied (based on C-RNTI), receiving a dedicated RNTI that is used as the indication to indicate whether multi-TRP PUCCH scheme should be applied. In an embodiment, the method may also include, at 210, receiving, from a network node, DCI carrying information related to the UCI to be transmitted. According to certain embodiments, the received DCI carrying information related to the UCI to be transmitted may be the same DCI received at 205 or it may be a different or separate DCI from that received at 205.

As further illustrated in the example of FIG. 2, in certain embodiments, when it is determined at 220 to apply a multi-TRP PUCCH scheme, then the method may include, at 225, interpreting at least one DCI field by considering the entire field (i.e., two subfields) in case of multi-TRP PUCCH scheme and determining two parameter values based on this field. According to some embodiments, when it is determined at 220 that a multi-TRP PUCCH scheme is not applied, then the method may include, at 230, interpreting at least one DCI field by considering one part or subfield in case of single-TRP PUCCH scheme and determining the parameter value based on this part or subfield.

It should be noted that, in some embodiments, the methods depicted in FIG. 1 and FIG. 2 may be combined. For instance, in one example embodiment, a UE may perform a method that includes receiving configuration information indicating that multi-transmission reception point (TRP) physical uplink control channel (PUCCH) scheme could be applicable. The method may then include the UE determining whether to apply the multi-TRP PUCCH scheme or a single-TRP PUCCH scheme for an uplink control information (UCI) transmission on a determined PUCCH resource. In an embodiment, the determining of whether to apply the multi-TRP scheme or single-TRP scheme may be performed according to the example of FIG. 1 or FIG. 2.

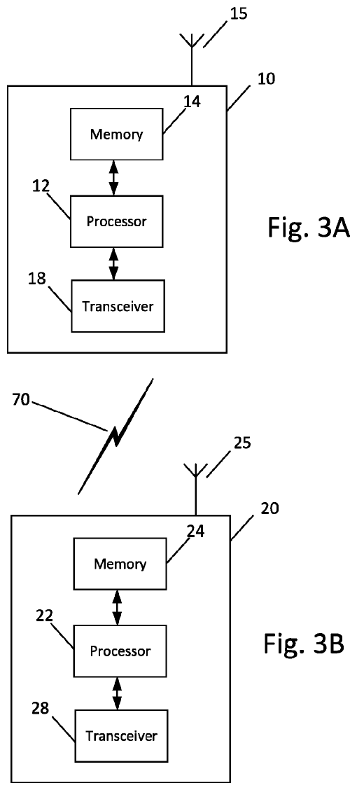

FIG. 3A illustrates an example of an apparatus 10 according to an embodiment. In an embodiment, apparatus 10 may be a node, host, or server in a communications network or serving such a network. For example, apparatus 10 may be a network node, a sensing node, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 3A.

As illustrated in the example of FIG. 3A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 3A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like. According to certain embodiments, apparatus 10 may be controlled by memory 14 and processor 12 to perform the functions associated with any of the embodiments described herein. For example, according to an embodiment, apparatus 10 may be controlled to perform a process relating to dynamic switching between a multi-TRP or single-TRP scheme.

In an embodiment, apparatus 10 may be controlled by memory 14 and processor 12 to transmit, to one or more UEs, configuration information indicating that multi-TRP PUCCH scheme could be applicable. According to one embodiment, apparatus 10 may be controlled by memory 14 and processor 12 to broadcast or transmit DCI carrying information related to UCI to be transmitted by the UE(s). In one example embodiment, apparatus 10 may be controlled by memory 14 and processor 12 to transmit, to one or more UEs, dedicated indication via DCI to indicate whether to apply multi-TRP PUCCH scheme or single-TRP PUCCH scheme.

FIG. 3B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 3B.

As illustrated in the example of FIG. 3B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 3B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, SL UE, relay UE, mobile device, mobile station, ME, IoT device and/or NB-IoT device, or the like, for example. In an embodiment, apparatus 20 may be controlled to perform a process relating to determining whether to apply a multi-TRP or single-TRP scheme. According to certain embodiments, apparatus 20 may be controlled by memory 24 and processor 22 to perform the functions associated with any of the embodiments described herein, such as one or more of the operations illustrated in, or described with respect to, FIG. 1 or FIG. 2 or any other method described herein.

In some embodiments, apparatus 20 may be controlled by memory 24 and processor 22 to receive configuration information that multi-TRP PUCCH scheme could be applicable. According to one example embodiment, apparatus 20 may be controlled by memory 24 and processor 22 to receive, from a network node, DCI carrying information related to the UCI to be transmitted by apparatus 20.

In an embodiment, apparatus 20 may be controlled by memory 24 and processor 22 to determine whether to apply multi-TRP PUCCH scheme or single-TRP PUCCH scheme, e.g., based on one or more of the factors (a)-(f) discussed above. For example, apparatus 20 may be controlled by memory 24 and processor 22 to determine whether to apply multi-TRP PUCCH scheme or single-TRP PUCCH scheme based on at least one of: the received configuration information, the determined PUCCH resource, whether one or two (different) spatial relation information have been indicated for this PUCCH resource, and/or the number of PUCCH repetitions.

According to another example embodiment, apparatus 20 may be controlled by memory 24 and processor 22 to receive, from a network node, dedicated indication via DCI to indicate whether to apply multi-TRP PUCCH scheme or single-TRP PUCCH scheme. For example, apparatus 20 may be controlled by memory 24 and processor 22 to receive/detect, in addition to current RNTI(s) that can be used to indicate that single-TRP scheme should be applied (based on C-RNTI), a dedicated RNTI that is used to indicate whether multi-TRP PUCCH scheme should be applied.

In certain embodiments, when it is determined or indicated to apply a multi-TRP PUCCH scheme, then apparatus 20 may be controlled by memory 24 and processor 22 to interpret at least one DCI field by considering the entire field (i.e., two subfields) in case of multi-TRP PUCCH scheme and determine two parameter values based on this field. According to some embodiments, when it is determined or indicated that a multi-TRP PUCCH scheme is not applied, then apparatus 20 may be controlled by memory 24 and processor 22 to interpret at least one DCI field by considering one part or subfield in case of single-TRP PUCCH scheme and determine the parameter value based on this part or subfield.

It is noted that, according to certain embodiments, apparatus 20 may be controlled by memory 24 and processor 22 to utilize the determination of whether to apply a multi-TRP or single-TRP scheme in FR1 and/or FR2 (or any other frequency range).

For instance, for FR2 and intra-slot and inter-slot PUCCH repetition schemes, if multi-TRP PUCCH scheme is configured via RRC and the UE determines a PUCCH resource for which two spatial relation information are indicated or activated, and the number of PUCCH repetitions is greater than one, then apparatus 20 may be controlled by memory 24 and processor 22 to determine to apply the multi-TRP PUCCH scheme. Otherwise, apparatus 20 may be controlled by memory 24 and processor 22 to determine to apply the single-TRP PUCCH scheme. As mentioned above, in certain embodiments, the number of repetitions may be configured separately for each PUCCH resource or may be jointly configured for a group of PUCCH resources, or can be explicitly indicated via DCI.

As another example, for FR2 and intra-slot PUCCH beam hopping scheme, if multi-TRP PUCCH scheme is configured via RRC and the UE determines a PUCCH resource for which two spatial relation information are indicated or activated, and the number of repetition is equal to one, then apparatus 20 may be controlled by memory 24 and processor 22 to determine to apply the multi-TRP PUCCH scheme. Otherwise, apparatus 20 may be controlled by memory 24 and processor 22 to determine to apply the single-TRP PUCCH scheme.

In another embodiment, for FR1 and intra-slot and inter-slot PUCCH repetition schemes, if multi-TRP PUCCH scheme is configured via RRC and the UE determines a PUCCH resource for which two subsets of power control parameters are indicated or activated, and the number of PUCCH repetitions is greater than one, then apparatus 20 may be controlled by memory 24 and processor 22 to determine to apply the multi-TRP PUCCH scheme. Otherwise, apparatus 20 may be controlled by memory 24 and processor 22 to determine to apply single-TRP PUCCH scheme. As mentioned above, in some embodiments, the number of repetitions may be configured separately for each PUCCH resource or may be jointly configured for a group of PUCCH resources or may be explicitly indicated via DCI.

According to a further embodiment, for FR1 and intra-slot PUCCH beam hopping scheme, if multi-TRP PUCCH scheme is configured via RRC and the UE determines a PUCCH resource for which two subsets of power control parameters are indicated or activated, and the number of repetition is equal to one, then apparatus 20 may be controlled by memory 24 and processor 22 to determine to apply the multi-TRP PUCCH scheme. Otherwise, apparatus 20 may be controlled by memory 24 and processor 22 to determine to apply the single-TRP PUCCH scheme.

In some embodiments, an apparatus (e.g., apparatus 10 and/or apparatus 20) may include means for performing a method or any of the variants discussed herein, such as the methods described with reference to FIGS. 1 and 2. Examples of the means may include one or more processors, memory, and/or computer program code for causing the performance of the operation.

In view of the foregoing, certain example embodiments provide several technological improvements, enhancements, and/or advantages over existing technological processes and constitute an improvement at least to the technological field of wireless network control and management. For example, as discussed in detail above, certain example embodiments provide systems and methods that provide the ability to dynamically switch between and/or to determine whether to apply multi-TRP PUCCH scheme or single-TRP PUCCH scheme. For example, certain example embodiments enable a UE to dynamically determine whether to apply multi-TRP PUCCH scheme or single-TRP PUCCH, and for at least one DCI field to determine corresponding parameter value(s) depending on the applicable PUCCH scheme. Such dynamic switching, and related DCI field interpretation, is advantageous especially for a UE that has different types of services (e.g. URLLC and eMBB), and thus where both multi-TRP and single TRP PUCCH schemes may need to be used for this UE. Accordingly, the use of certain example embodiments results in improved functioning of communications networks and their nodes, such as base stations, eNBs, gNBs, and/or IoT devices, UEs or mobile stations.

A first embodiment is directed to a method, which may include receiving, at a user equipment, configuration information indicating that multi-transmission reception point (TRP) physical uplink control channel (PUCCH) scheme could be applicable, and determining, at the user equipment, whether to apply the multi-TRP PUCCH scheme or a single-TRP PUCCH scheme for an uplink control information (UCI) transmission on a determined PUCCH resource.

In a variant, the determining of whether to apply the multi-TRP PUCCH scheme or a single-TRP PUCCH scheme includes determining whether to apply multi-TRP PUCCH scheme or single-TRP PUCCH scheme based on at least one of: the received configuration information, the determined PUCCH resource, whether one or two different spatial relation information have been indicated or activated for the PUCCH resource, whether one or two subsets of power control parameters have been indicated or activated for the PUCCH resource, or indicated or configured number of PUCCH repetitions.

In another variant, the determining of whether to apply the multi-TRP PUCCH scheme or a single-TRP PUCCH scheme includes receiving, from a network node, a dedicated indication via downlink control information (DCI) to indicate whether to apply the multi-TRP PUCCH scheme or single-TRP PUCCH scheme.

According to a variant, the method may also include receiving, from a network node, downlink control information (DCI) carrying information related to uplink control information (UCI) to be transmitted.

In a variant, when it is determined to apply the multi-TRP PUCCH scheme, the method may include interpreting at least one DCI field by considering an entirety of the at least one field in case of the multi-TRP PUCCH scheme and determining two parameter values based on the at least one field.

According to a variant, when it is determined that the multi-TRP PUCCH scheme is not applied, the method may include interpreting at least one DCI field by considering one part or subfield of the at least one field in case of single-TRP PUCCH scheme and determining a parameter value based on the one part or subfield.

In a variant, for example mainly for frequency range 2 (FR2), when the multi-TRP PUCCH scheme is configured via radio resource control (RRC), a PUCCH resource is determined for which two spatial relation information are indicated or activated, and the number of PUCCH repetitions is greater than or equal to one, the determining comprises determining to apply the multi-TRP PUCCH scheme.

In another variant, for example mainly for frequency range 1 (FR1), when multi-TRP PUCCH scheme is configured via radio resource control (RRC), a PUCCH resource is determined for which two subsets of power control parameters are indicated or activated, and the number of PUCCH repetitions is greater than or equal to one, the determining comprises determining to apply the multi-TRP PUCCH scheme.

A second embodiment is directed to an apparatus including at least one processor and at least one memory comprising computer program code. The at least one memory and computer program code may be configured, with the at least one processor, to cause the apparatus at least to perform the method according to the first embodiment, and/or any other embodiments discussed herein, or any of the variants described above.

A third embodiment is directed to an apparatus that may include circuitry configured to perform the method according to the first embodiment, and/or any other embodiments discussed herein, or any of the variants described above.

A fourth embodiment is directed to an apparatus that may include means for performing the method according to the first embodiment, and/or any other embodiments discussed herein, or any of the variants described above.

A fifth embodiment is directed to a non-transitory computer readable medium comprising program instructions stored thereon for performing at least the method according to the first embodiment, and/or any other embodiments discussed herein, or any of the variants described above.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-28. (canceled)

29. A method, comprising:
receiving, at a user equipment, configuration information indicating that multi-transmission reception point physical uplink control channel scheme could be applicable; and
determining, at the user equipment, whether to apply the multi-transmission reception point physical uplink control channel scheme or a single-transmission reception point physical uplink control channel scheme for an uplink control information transmission on a determined physical uplink control channel resource.

30. The method according to claim 29, wherein the determining comprises determining whether to apply multi-transmission reception point physical uplink control channel scheme or single-transmission reception point physical uplink control channel scheme based on at least one of:
the received configuration information,
the determined physical uplink control channel resource,
whether one or two different spatial relation information have been indicated or activated for the physical uplink control channel resource, whether one or two subsets of power control parameters have been indicated or activated for the physical uplink control channel resource, or indicated or configured number of physical uplink control channel repetitions.

31. The method according to claim 29, wherein the determining comprises receiving, from a network node, a dedicated indication via downlink control information to indicate whether to apply the multi-transmission reception point physical uplink control channel scheme or single-transmission reception point physical uplink control channel scheme.

32. The method according to claim 29, further comprising receiving, from a network node, downlink control information carrying information related to uplink control information to be transmitted.

33. The method according to claim 29, wherein, when it is determined to apply the multi-transmission reception point physical uplink control channel scheme, the method comprises:
interpreting at least one downlink control information field by considering an entirety of the at least one field in case of the multi-transmission reception point physical uplink control channel scheme and determining two parameter values based on the at least one field.

34. The method according to claim 29, wherein, when it is determined that the multi-transmission reception point physical uplink control channel scheme is not applied, the method comprises:
interpreting at least one downlink control information field by considering one part or subfield of the at least one field in case of single-transmission reception point physical uplink control channel scheme and determining a parameter value based on the one part or subfield.

35. The method according to claim 29, wherein, when at least one of a physical uplink control channel resource is determined for which two spatial relation information are indicated or activated, or the number of physical uplink control channel repetitions is greater than one,
the determining comprises determining to apply the multi-transmission reception point physical uplink control channel scheme.

36. The method according to claim 29, wherein, when at least one of a physical uplink control channel resource is determined for which two subsets of power control parameters are indicated or activated, or the number of physical uplink control channel repetitions is greater than one or equal to one,
the determining comprises determining to apply the multi-transmission reception point physical uplink control channel scheme.

37. The method according to claim 29, wherein the configuration information is received via at least one of radio resource control or medium access control control element.

38. An apparatus, comprising:
at least one processor; and
at least one memory comprising computer program code,
the at least one memory and computer program code configured, with the at least one processor, to cause the apparatus at least to:
receive configuration information indicating that multi-transmission reception point physical uplink control channel scheme could be applicable; and
determine whether to apply the multi-transmission reception point physical uplink control channel scheme or a single-transmission reception point physical uplink control channel scheme for an uplink control information transmission on a determined physical uplink control channel resource.

39. The apparatus according to claim 38, wherein the at least one memory and computer program code are configured, with the at least one processor, to cause the apparatus at least to determine whether to apply multi-transmission reception point physical uplink control channel scheme or single-transmission reception point physical uplink control channel scheme, based on at least one of:
the received configuration information,
the determined physical uplink control channel resource,
whether one or two different spatial relation information have been indicated or activated for the physical uplink control channel resource, whether one or two subsets of power control parameters have been indicated or activated for the physical uplink control channel resource, or indicated or configured number of physical uplink control channel repetitions.

40. The apparatus according to claim 38, wherein, to determine whether to apply multi-transmission reception point physical uplink control channel scheme or single-transmission reception point physical uplink control channel scheme, the at least one memory and computer program code are configured, with the at least one processor, to cause the apparatus at least to:
receive, from a network node, a dedicated indication via downlink control information to indicate whether to apply the multi-transmission reception point physical uplink control channel scheme or single-transmission reception point physical uplink control channel scheme.

41. The apparatus according to claim 38, wherein the at least one memory and computer program code are configured, with the at least one processor, to cause the apparatus at least to:
receive, from a network node, downlink control information carrying information related to uplink control information to be transmitted.

42. The apparatus according to claim 38, wherein, when it is determined to apply the multi-transmission reception point physical uplink control channel scheme, the at least one memory and computer program code are configured, with the at least one processor, to cause the apparatus at least to:
interpret at least one downlink control information field by considering an entirety of the at least one field in case of the multi-transmission reception point physical uplink control channel scheme and determine two parameter values based on the at least one field.

43. The apparatus according to claim 38, wherein, when it is determined that the multi-transmission reception point physical uplink control channel scheme is not applied, the at least one memory and computer program code are configured, with the at least one processor, to cause the apparatus at least to:
interpret at least one downlink control information field by considering one part or subfield of the at least one field in case of single-transmission reception point physical uplink control channel scheme and determine a parameter value based on the one part or subfield.

44. The apparatus according to claim 38, wherein, when at least one of a physical uplink control channel resource is determined for which two spatial relation information are indicated or activated, or the number of physical uplink control channel repetitions is strictly greater than one,
the at least one memory and computer program code are configured, with the at least one processor, to cause the apparatus at least to determine to apply the multi-transmission reception point physical uplink control channel scheme.

45. The apparatus according to claim 38, wherein, when at least one of a physical uplink control channel resource is determined for which two subsets of power control parameters are indicated or activated, or the number of physical uplink control channel repetitions is greater than one or equal to one,
the at least one memory and computer program code are configured, with the at least one processor, to cause the apparatus at least to determine to apply the multi-transmission reception point physical uplink control channel scheme.

46. The apparatus according to claim 38, wherein the configuration information is received via at least one of radio resource control or medium access control control element.

47. A non-transitory computer readable medium comprising program instructions stored thereon, which when executed by at least one processor, cause an apparatus at least to:
receive configuration information indicating that multi-transmission reception point physical uplink control channel scheme could be applicable; and
determine whether to apply the multi-transmission reception point physical uplink control channel scheme or a single-transmission reception point physical uplink control channel scheme for an uplink control information transmission on a determined physical uplink control channel resource.
